(19) United States
(12) Patent Application Publication
(10) Pub. No.: US 2007/0075091 A1
(43) Pub. Date: Apr. 5, 2007

(54) Hand sanitizer holder

(76) Inventors: Louis Tombazzi, Strongsville, OH (US); Phillip Ozimek, Brecksville, OH (US); Mitchell D. Opalich, Euclid, OH (US); Curtis Taylor, Chagrin Falls, OH (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/504,986

(22) Filed: Aug. 16, 2006

Related U.S. Application Data
(60) Provisional application No. 60/708,841, filed on Aug. 17, 2005.

(51) Int. Cl. B67D 5/00

(52) U.S. Cl. 222/82

(57) ABSTRACT

An improved device is used for carrying hand sanitizers. The device can be a hand sanitizer belt holder or a pen. The hand sanitizer belt holder has a holder body, a belt loop, and an aperture that attach to a belt and has an opening for accepting a bottle or container of hand sanitizer. The cap of the hand sanitizer bottle extends through the aperture so that the user can access the contents of the bottle of hand sanitizer. The pen has a first outer shell and a second outer shell that are attached to each other using a hinge. When the first outer shell and second outer shell are opened, a gel cartridge of sanitizer can be inserted into the pen. After the gel cartridge is inserted and the pen is closed, the pen has a slider that moves down a track for dispensing gel.

### PRIORITY DATA

This application claims priority from U.S. application Ser. No. 60/708,841, filed on Aug. 17, 2005.

### FIELD OF THE INVENTION

The present invention is generally related to hand sanitizer holders attachable to a person.

### BACKGROUND OF THE INVENTION

The medical community has determined that the spread of germs and viruses are a main cause of many illnesses. Thus, persons use hand sanitizers in an attempt to curtail the spread of these illness-causing germs. The use of hand sanitizers has become very common to prevent the spread of germs and viruses into a person. This is especially true of persons in the medical community as such persons are exposed to such germs and viruses. It is imperative for their hands to remain as germ free as possible, especially when treating patients. Hand sanitizers have proven a very valuable tool for this.

It is often, however, difficult and cumbersome for medical personnel that go from place to place to carry a bottle of hand sanitizer with them. Such a person will often either have to rely on a bottle of hand sanitizer to be in a location near where they need it, or will have to carry it with them. One particular difficulty is that many such medical personnel wear surgical scrubs that do not have pockets sufficiently large enough to hold a bottle of hand sanitizer.

Additionally, it is often difficult to carry a bottle of hand sanitizer for a person outside of the medical industry that is on the move and does not have a place to keep a bottle of hand sanitizer or do not otherwise have access to a bottle of hand sanitizer. For example, a family that goes to an amusement park desire to have a bottle of hand sanitizer, but is unable to carry one with them because they have nothing in which to carry it. There is, therefore, a need for a holder that attaches on to a person to hold and carry a bottle of hand sanitizer.

The preferred embodiments of the invention will be set forth in the description which follows, and in part will be obvious from the description, or may be learned by practice of the invention.

### DESCRIPTION OF THE DRAWINGS

The preferred embodiments of the invention may be better understood by reference to the following detailed description taken in connection with the following illustrations, wherein:

FIG. 1 is a bottom view perspective of a belt holder for a bottle of hand sanitizer according to an embodiment of the present invention;

FIG. 2 is a side view of the belt holder for a bottle of hand sanitizer according to an embodiment of the present invention;

FIG. 3 is a rear view of the belt holder for a bottle of hand sanitizer according to an embodiment of the present invention;

FIG. 4 is a top view of the belt holder for a bottle of hand sanitizer according to an embodiment of the present invention;

FIG. 5 is a view of the gel cartridge and the pen cartridge;

FIG. 6 is a view of the gel cartridge inside the pen cartridge;

FIGS. 7-11 are views of the pen cartridge closed; and

FIGS. 12-13 are views of the gel cartridge.

### DETAILED DESCRIPTION OF THE PREFERRED EMBODIMENTS

While the present invention is described with reference to the embodiments described herein, it should be clear that the present invention should not be limited to such embodiments. Therefore, the description of the embodiments herein is illustrative of the present invention and should not limit the scope of the invention as claimed.

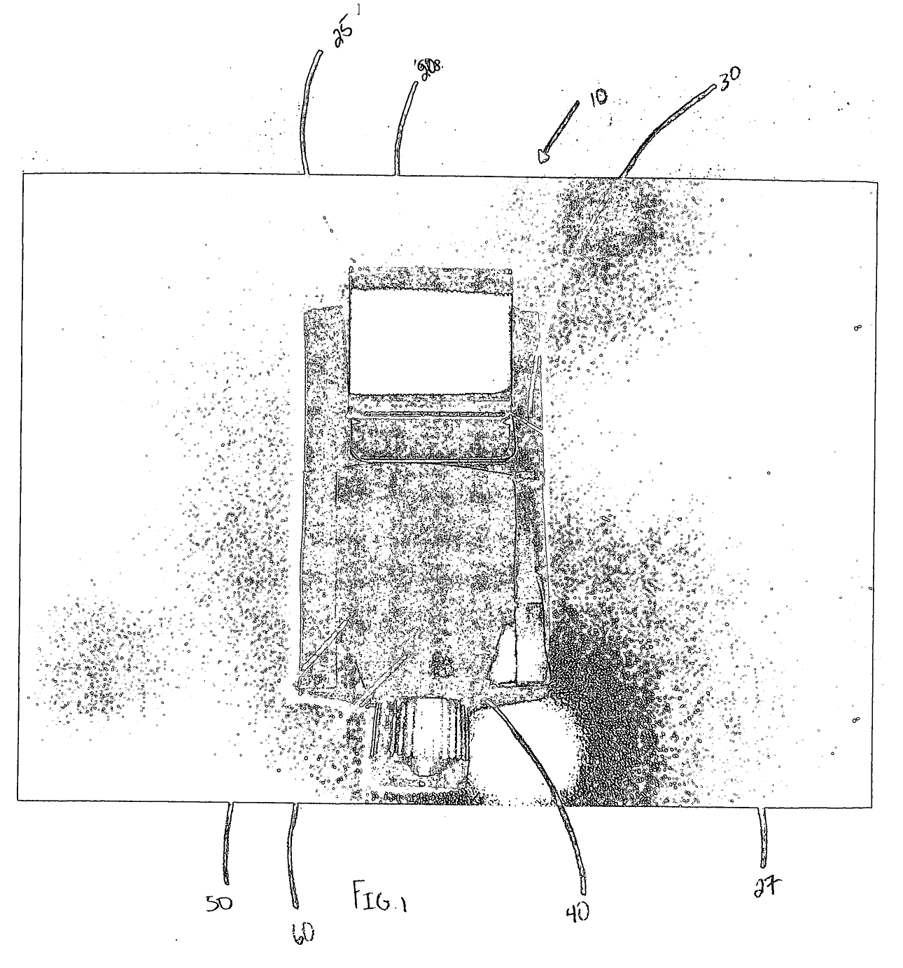

Reference will now be made in detail to one of the embodiments of the invention as illustrated in the accompanying drawings. Shown in FIG. 1 is a holder 10 for a container such as a fluid dispenser, including, without limitation a bottle 60 of hand sanitizer shown in the drawings. The holder 10 comprises a belt loop 20 attached to a holder body 30. The belt loop 20 shown in the drawings is made of metal. It is formed by starting with a straight and flat piece of metal and bending a loop 25 therein and then bending a portion 27 back up. This creates a belt loop 20 that is very easy to attach to a user's belt or otherwise to a wearer's pants, such as the waist or pockets of such pants. It should be understood, however, that the belt loop 20 may be made of alternative materials, such as plastic, or hard rubber. The belt loop 20 may also be coated with rubber, plastic, cloth, canvas, or such other softer material, especially if the belt loop 20 is made of metal. Additionally, the belt loop 20 may be formed by casting, injection molding, forging, or any other such method.

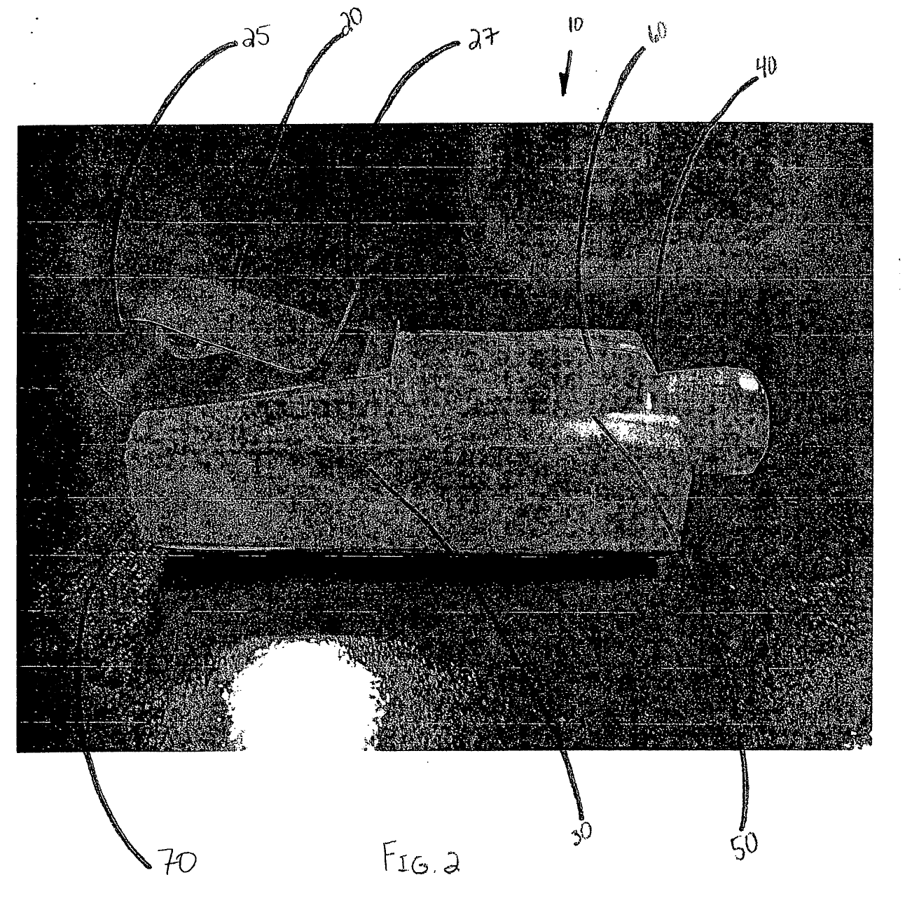

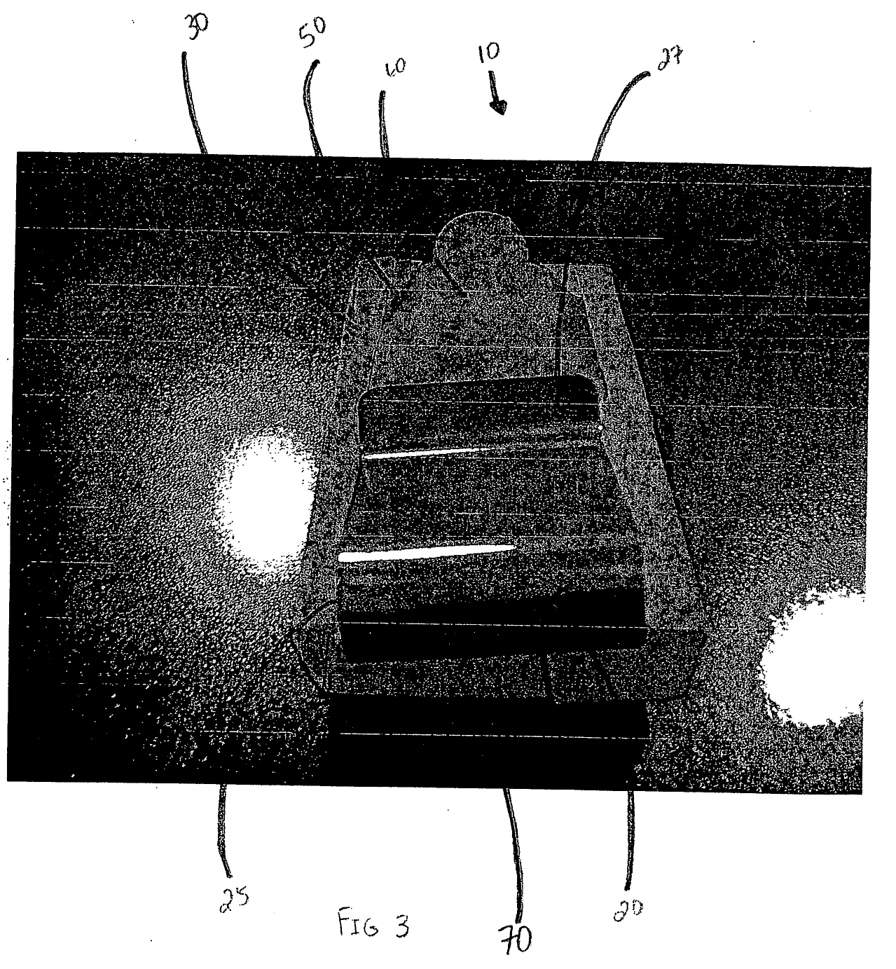

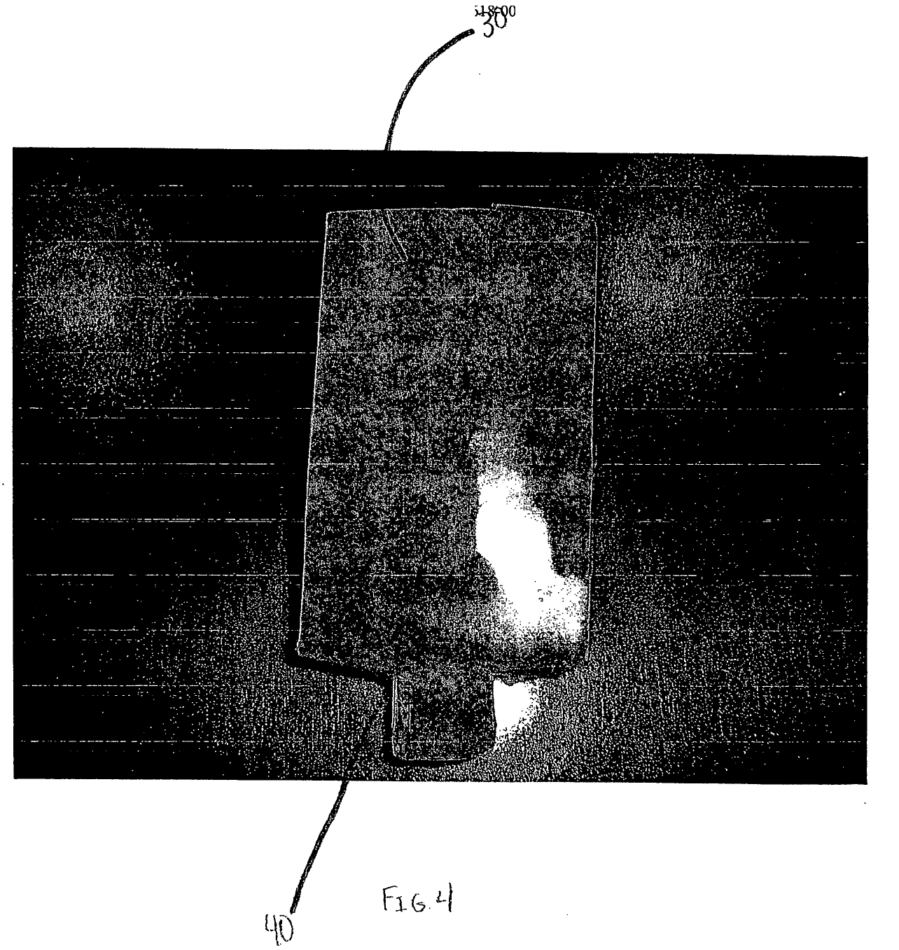

The holder body 30 comprises an aperture 40 sized to permit the cap portion of a container or bottle 60 of hand sanitizer to extend out of the holder body 30 to allow access to the contents of the container or bottle of hand sanitizer. Additionally, the holder body 30 comprises a window portion 50 that allows a user to determine the amount of contents remaining in the container or bottle of hand sanitizer. The window portion 50 is useful because it allows a user to determine when a container or bottle of hand sanitizer needs to be replaced without having to pull it out of the holder 10. Finally, as seen in FIGS. 2 and 3, the holder body 30 comprises a pocket 70 having an opening allowing insertion and holding of the container or bottle of hand sanitizer in the holder 10.

The holder body 30 may be made of just about any material. It could be made of metal, plastic, rubber, cloth, canvas, cardboard, etc. The material must be sufficiently strong and rigid to hold the bottle or container 60 of the hand sanitizer. Preferably, the material of the holder body 30 is water proof or water resistant. This will lengthen the useful life of the holder body 30. Invariably the holder body 30 will come in contact with the contents of the hand sanitizer bottle or container 60. Therefore, if the material is water resistant or water proof, the holder body 30 will not become damaged.

In operation, a user would insert a bottle or container 60 of hand sanitizer into the holder 10. More specifically, the user would insert the bottle 60 of hand sanitizer into the pocket 70 in the holder body 30. The cap of the hand sanitizer bottle 60 would extend through the aperture 40 so that the user can access the contents of the bottle of hand sanitizer. Next, the user places the belt loop 20 over a belt or over a waist of pants until the loop portion 25 rests against the belt or waist and is held in place. The bottle 60 of hand sanitizer is now firmly held in the holder 10 and the user can access the hand sanitizer anytime he or she wishes and is not required to carry the bottle in a pocket, in a separate bag, or in their hands.

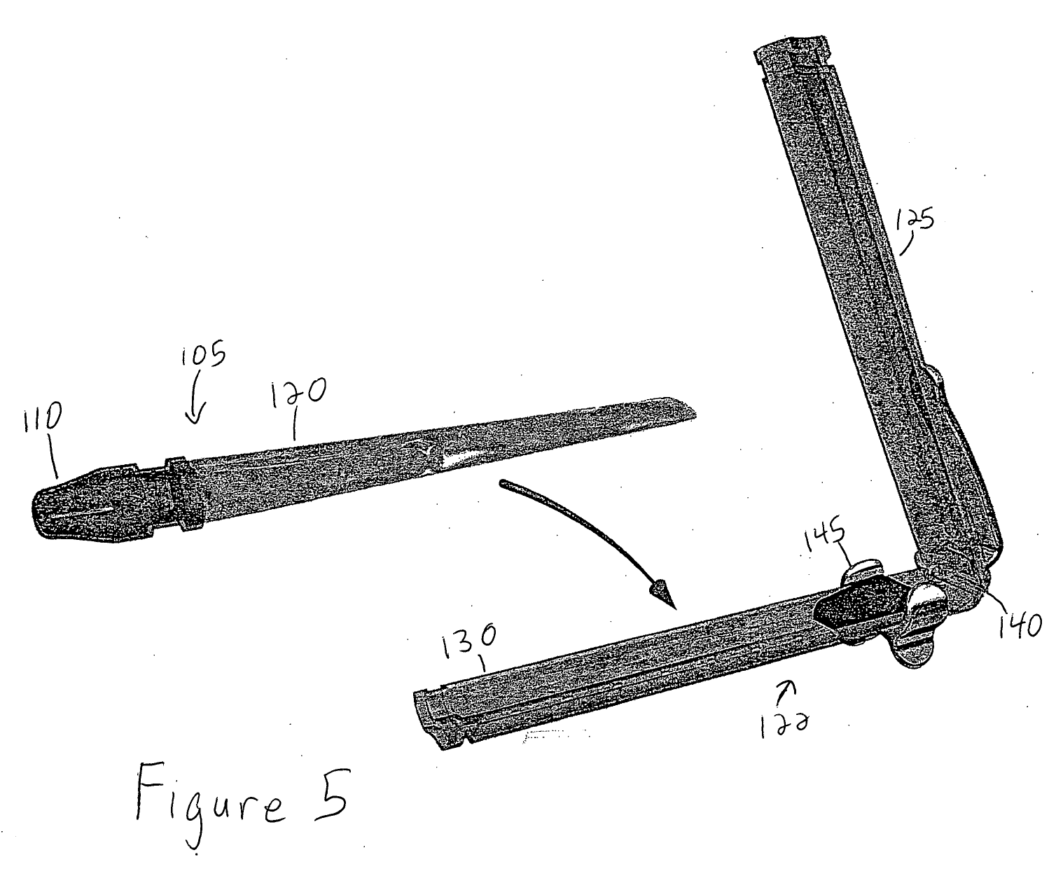

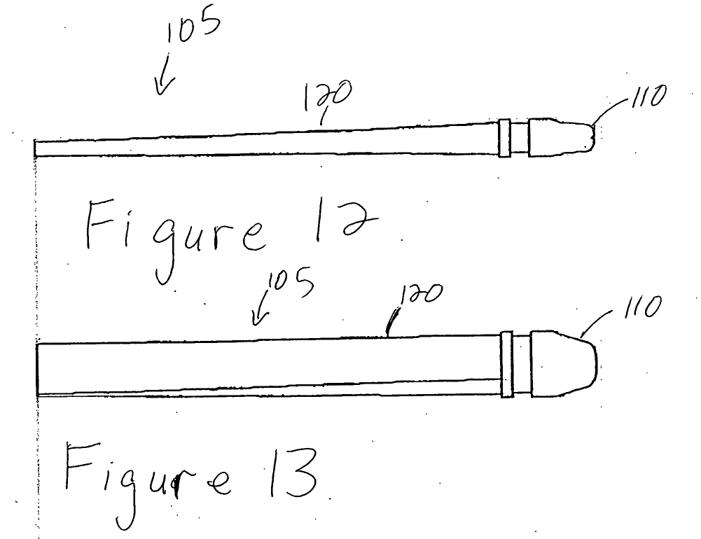

FIGS. 5, 12, and 13 shows the gel cartridge 105 having a full control mechanism 110 and a gel end 120. As shown in FIG. 12, the gel cartridge 105 preferably has a narrower gel end at the section furthest away from the full control mechanism 110 and the gel end 120 gets wider as it gets closer to the full control mechanism 110.

Referring back to FIG. 5, pen cartridge 122 has a first outer shell portion 130 and a second outer shell portion 125. The first outer shell portion 130 and the second outer shell portion 125 are connected via hinge 140 that enables each shell portion to open and accept the gel cartridge 105, as illustrated in FIG. 6, and close to secure the gel cartridge 105. Clips 145 help hold the gel cartridge 105 in place by securing the first outer shell 130 portion and the second outer shell 125 portion together in a closed position.

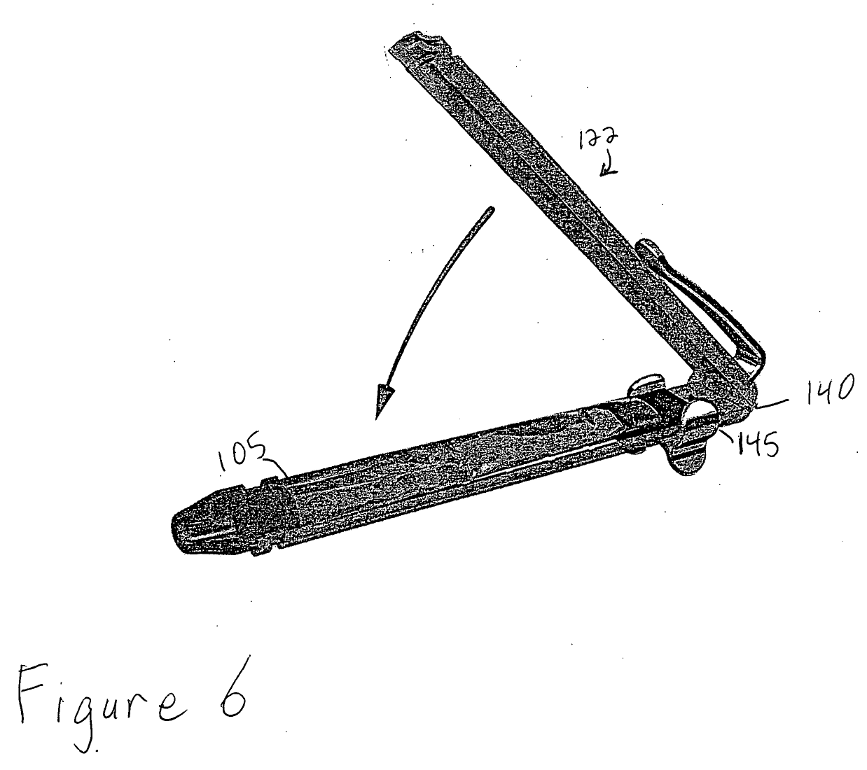

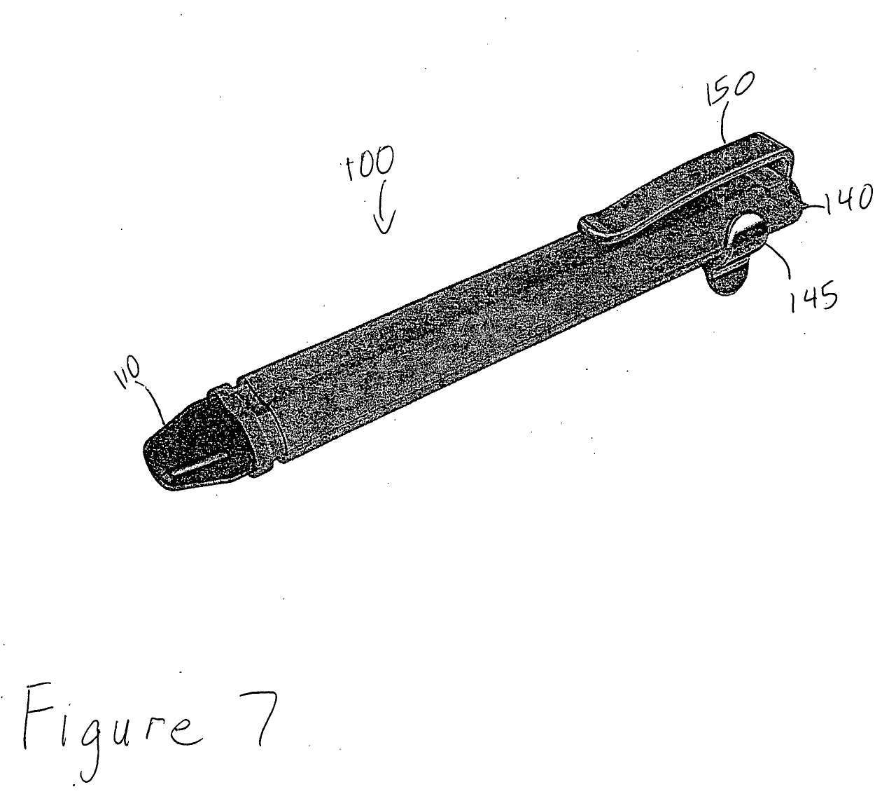

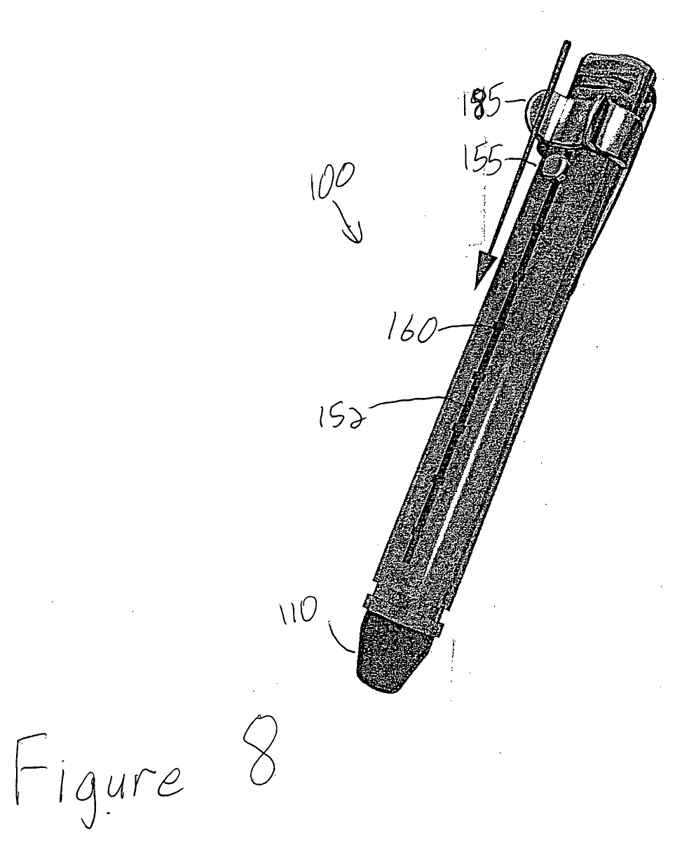

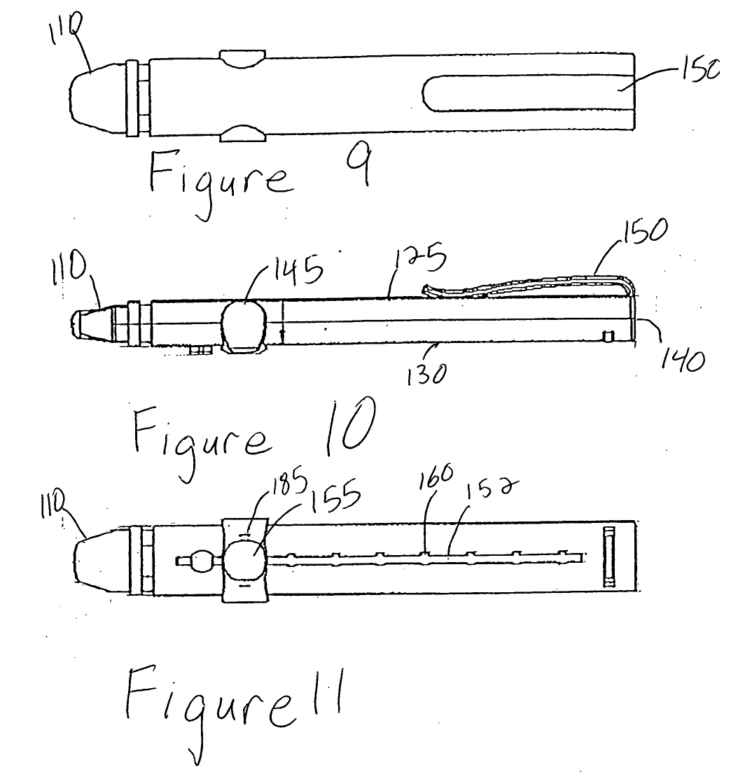

FIGS. 7, 9, and 10 show the pen 100 in a closed position with the assistance of hinge 140. Pen 100 includes pen clip 150 that can be used for clipping the pen onto a person's clothes. FIGS. 8 and 11 illustrate the pen 100 with a slider 185. The slider 185 is moved down the track 152 and locks into place with the assistance of stopper 155. Stopper 155 stops in each notch 160 along the track 152. As the slider 185 moves down the track 152, the gel is squeezes down the cartridge and out the full control mechanism 110.

The invention has been described above and, obviously, modifications and alterations will occur to others upon a reading and understanding of this specification. The claims as follows are intended to include all modifications and alterations insofar as they come within the scope of the claims or the equivalent thereof.

Have thus described the invention, it is claimed:

1. A pen dispensing sanitizing gel comprising:
a gel cartridge wherein the gel cartridge includes a dispensing end and a gel end;
a pen cartridge wherein the pen cartridge includes a first outer shell portion and a second outer shell portion said first and second outer portion connected by a hinge; and
wherein said hinge opens first outer shell portion and said second outer shell portion to accept at least a portion of said gel cartridge.

2. The pen of claim 1, further comprising at least one clip for securing said first outer shell portion and said second outer shell portion together in a closed position.

3. The pen of claim 1, further comprising a track with notches on one of said first and second outer portions.

4. The pen of claim 3, wherein said track further comprises a stopper stopping on said notches.

5. The pen of claim 3, wherein said track further comprises a slider connected to said gel cartridge and moving along said track.

6. The pen of claim 5, wherein said slider pushes gel in said gel cartridge towards said dispensing end.

7. The pen of claim 1, wherein at least a portion of said dispensing end extends outwardly from said first and second outer shell.

8. A hand sanitizer belt holder comprising:
a belt loop attached to a holder body;
wherein said holder body includes an aperture and a window portion;
wherein said aperture sized to permit a cap portion of a container or bottle to extend out of said holder body; and
wherein said window portion shows amount of contents remaining in said container or bottle.

9. The hand sanitizer belt holder of claim 8, wherein said holder body further comprises an opening to accept said bottle or said container.
